(19) United States
(12) Patent Application Publication
(10) Pub. No.: US 2007/0029747 A1
(43) Pub. Date: Feb. 8, 2007

(54) Module and a kit for constructing different variations of vehicles as well as a vehicle constructed from such a kit

(75) Inventors: Henry Islo, Skyttegatan (SE); Ojvind Tunsbrunn, Ryavagen (SE)

Correspondence Address: YOUNG & THOMPSON, 745 SOUTH 23RD STREET, 2ND FLOOR, ARLINGTON, VA, 22202, US

(73) Assignee: NATURE NIGH SWEDEN AB, Sigtuna (SE)

(21) Appl. No.: 10/568,880

(22) PCT Filed: Aug. 17, 2004
(86) PCT No.: PCT/SE04/01201

§ 371 Date: Feb. 21, 2006

Related U.S. Application Data
(60) Provisional application No. 60/495,724, filed on Aug. 18, 2003.

(30) Foreign Application Priority Data
Aug. 18, 2003 (SE) 0302235-7

(51) Int. Cl. B62B 3/00

(52) U.S. Cl. 280/47.35

(57) ABSTRACT

One aspect of the invention relates to a building or component kit intended for constructing different variations of vehicles. The kit includes a number of connecting members as well as unique modules; for example, wheel modules, which includes a carrier (6) with elements (17) for holding a wheel or some other kind of running member (7), as well as a number of sockets (12, 13) for receiving connecting members (4), in which sockets the connecting members can be disengageably applied. Another aspect of the invention relates to the wheel module as such.

### BACKGROUND OF THE INVENTION AND DESCRIPTION OF THE PRIOR ART

Many different types of vehicles of highly variable character are used for surface transport over land as well as over water. These can be categorized from different view points. On solid ground, like bare earth, wheel borne carriages or carts are the primary means of transport. These can be manually driven (i.e. using muscular power) or motor driven (i.e. self propelled). Regardless of the means of propulsion such vehicles can be set in motion either through pulling (e.g. bicycle carts, handcarts, trailers, etc.) or through pushing (e.g. wheelbarrows, baby buggies, etc.). Furthermore, wheel borne vehicles can be categorized according to the number of wheels; more precisely single wheeled and multi-wheeled respectively, whereof the latter usually utilizes two, three or four wheels. In addition certain wheel borne vehicles can be steered in that one or more of the wheels can be turned or swivelled relative to the other wheels, while other types of vehicle can only be passively moved along without their own steering capability. Other vehicles are meant to be driven over snow and/or ice covered surfaces and are therefore equipped with other running members (the member or members of the vehicle that are in contact with the surface) than wheels; for example, skis, sledge runner or the like. Still other vehicles are meant to be driven on water and are therefore equipped with running members such as hulls, pontoons, buoyant skis, etc. To this can be added vehicles such as hovercrafts, hydrocopters and the like, which can travel over land as well as over water while riding on air cushions; i.e. they lack running members of the kind that are in direct physical contact with the surface during travel.

There exist at least as many actual vehicle types as there are conceivable application areas for these vehicles. Vehicles for transport of people and/or freight are not only used for utility purposes but also for diversion and amusement purposes, i.e. highly varying types of recreational activities. However, a common characteristic for vehicles manufactured according to older techniques is that a specific vehicle was given a functional design that was determined once and for all. For example, a bicycle cart was and always would be a cart for bicycles even if this cart in extraordinary circumstances was used for more or less odd applications not necessarily connected to a bicycle. A consequence and disadvantage of this technique is, however, that one and the same person, natural or juridical, is compelled to supply herself with a number of different vehicles to satisfy all the various needs that arise in life or in the organization. As one example, chosen from a range of possible real cases, consider the following situation of a man on his summer vacation who wants to both go long-distance bicycling and canoeing. This person can be in a situation that requires him to purchase a bicycle cart as well as a special two wheeled vehicle for portage of his canoe between different water-courses. If this person during the winter is interested in snowmobile driving as well, a completely different auxiliary vehicle will be needed, namely a snowmobile sled.

With the aim to remedy the economic, practical and other disadvantages in connection with the necessity of acquiring a specific vehicle for each transport application, multifunctional vehicles have during recent times been developed; more precisely vehicles which can be converted in such a way that one and the same vehicle can be used in fundamentally different ways. Thus, through U.S. Pat. No. 5,176,395 a four wheeled vehicle is known that is convertible mainly between a baby buggy and a bicycle trailer. When the vehicle is used as a baby buggy the vehicle includes three wheels, namely a front, central wheel and two back wheels. In order to push the buggy forward a u-formed, backward extending handle is mounted to the frame of the trailer. When the buggy is to be converted to a bicycle cart the front wheel as well as the backward extending U-handle are removed. Thereafter a thill-like fork is attached to the front part of the frame allowing attachment to a bicycle. Furthermore, the vehicle can be converted into a third configuration through the addition of a sled bottom, which allows the vehicle to be drawn by a skier or a dog.

Further, through US 2003/0062707 A1 a trailer is known that besides a hitch shaft also includes two foldable wheel units, which on the one hand in a folded out position make the trailer wheel borne and on the other hand in a folded in position reduce the volume of the trailer with the aim of facilitating storage and transport. In other words the vehicle can in general be converted between an active state for use and an inactive, non-usable state.

Finally, in DE 29701874 U1 a vehicle is described that can be converted between several different states, for example, from a trailer configuration suitable for hitching to a pulling vehicle to a manually driven configuration that forms a push cart (handcart), sack cart, baggage trolley or the like. The possibility to convert this vehicle between different states is based on the utilization of elastic tube clamps in combination with adjustable profiles.

The mutual characteristics demonstrated by these earlier known multifunctional vehicles, which are discussed above, are that they always use one and the same basic frame in their different states of conversion and that conversion is accomplish through changing the number of wheels and/or the position of the wheels relative to the frame. Common for these known vehicles is also that they are primarily wheel borne. In any case they can not in any configuration be driven on water. For this and other reasons the flexibility of the vehicles is fairly limited with respect to different areas of application.

### OBJECTS AND FEATURES OF THE INVENTION

The presented invention aims at obviating the above mentioned inconveniences associated with previously known vehicles and at providing the prerequisites for constructing vehicles having drastically improved flexibility with regard to possible areas of application. In a first aspect the invention is therefore aiming at providing a building or component kit for construction of highly disparate variations of vehicles. A primary object of this kit is that, extending from simple and inexpensive components, it shall make possible the construction of vehicles with a nearly endless variation on design and construction not merely with respect to the number of wheels and their placement but also with regard to the requisite vehicle frame; all in the ultimate objective to create the prerequisites for the user to quickly and simply, and in an arbitrary place, assemble a vehicle that fulfils unforeseen needs. To take a concrete example, from a range of imaginable examples, consider the situation that arises when a canoeist wants to get out of the water and portage his/her canoe from the beach to a parked bicycle some distance away. A kit packed in the canoe allows the canoeist to assemble a canoe wagon; i.e. a multi-wheeled vehicle which bears the canoe when the user pulls the canoe while walking to a bicycle some distance from the beach, whereupon the vehicle in some simple operations is transformed into a bicycle cart for further transport of the canoe by bicycle.

According to the invention the primary object is attained through the inventive kit by means of the characterizing features which are stated in the independent claim 10. Advantageous embodiments of the kit according to the invention are further specified in the dependent claims 11-14.

In another aspect the invention also relates to a module included in the kit according to the invention. In the case where the desired vehicle shall be wheel borne, said module consists of a wheel module, but said module may also comprise running members other than wheels; for example, skis, pontoons or the like. The characterizing features for this module are apparent from the independent claim 1. The advantageous embodiments of this module according to the invention are further stated in the dependent claims 2-9.

In a third aspect the invention also relates to a vehicle as such. The characterizing features for this vehicle are apparent from claim 15.

### SUMMARY OF THE INVENTION

The invention is based on the intention of using a number of modules in combination with a number of connecting members with the purpose of connecting different modules with one another. Each module shall comprise a universally applicable carrier, which in turn comprises means for attaching; for example, a wheel or other running member, such as a ski or the like, said carrier comprising a number of sockets in which connecting members can be attached. The connecting members can have different configurations, but are primarily long and narrow and in practice may consist of slender tubes or hollow profiles. In its preferred embodiment the kit's basic component, namely the universally applicable module, is manufactured with several sockets of which some are arranged at an angle, in particularly at a right angle to one another. In this way, for example, a four wheeled vehicle can be simply built by connecting two modules using one or more transverse connecting members forming a pair of wheels that in turn may be connected to a similar pair of wheels using longitudinal connecting members. As is apparent from the following detailed description of different embodiments of the invention, the inventive module allows itself to be used for construction of a nearly endless number of vehicles from simple single wheeled vehicles to complicated multi-wheeled vehicles.

Already here it is motivated to point out that the invention through its universality creates certain terminological difficulties. In many states of conversion the carrier of the module according to the invention, is equipped (temporarily or steadily) with a wheel to permit construction of wheel borne vehicles. In this case the module can therefore be considered to be a wheel module. However, in other applications the carrier of the module can be equipped (temporarily or steadily) with other running members than just wheels. Earlier mentioned examples of such running members are skis and pontoons. Thus, the concept “running member” shall be understood to mean every type of component that can have contact with and that runs along the bearing surface (solid ground or water) and at the same time bears up the carrier of the module.

### BRIEF DESCRIPTION OF THE APPENDED DRAWINGS

With reference to the drawings:

FIG. 1: a perspective view of a wagon constructed from a kit according to the invention,

FIG. 2: an enlarged and exploded perspective view showing a wheel module included in the kit as well as parts of a number of connecting members included in the kit,

FIG. 3: a similar exploded view showing a carrier of the module, without the appurtenant wheel,

FIG. 4: a perspective view of an alternative embodiment of a module,

FIG. 5: a perspective view of a third alternative embodiment of a module,

FIG. 6: a perspective view of a fourth alternative embodiment of a module,

FIG. 7: a perspective view of a mere carrier in yet another alternative embodiment of a module,

FIG. 8: a simple side view showing a module with another running member different from a wheel, namely a pontoon,

FIG. 9: a side view of a module with a ski as a running member, and

FIG. 10-18: perspective views illustrating a number of vehicles that are constructed from a kit according to the invention; FIGS. 10 and 11 showing one-wheelers, FIGS. 12-14 showing two-wheelers, FIGS. 15 and 16 a four wheeled vehicle and FIGS. 17 and 18 showing three wheeled vehicles.

### DETAILED DESCRIPTION OF PREFERRED EMBODIMENTS OF THE INVENTION

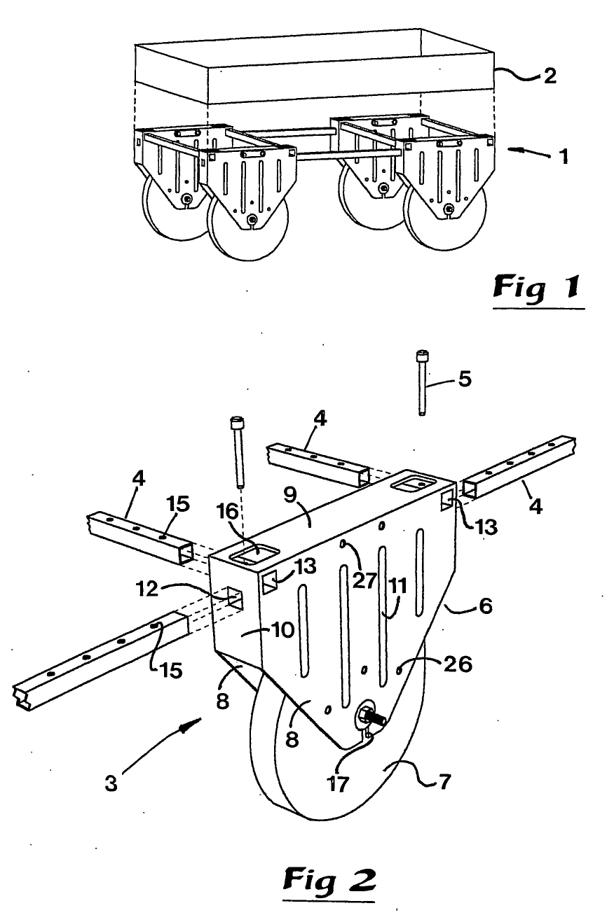

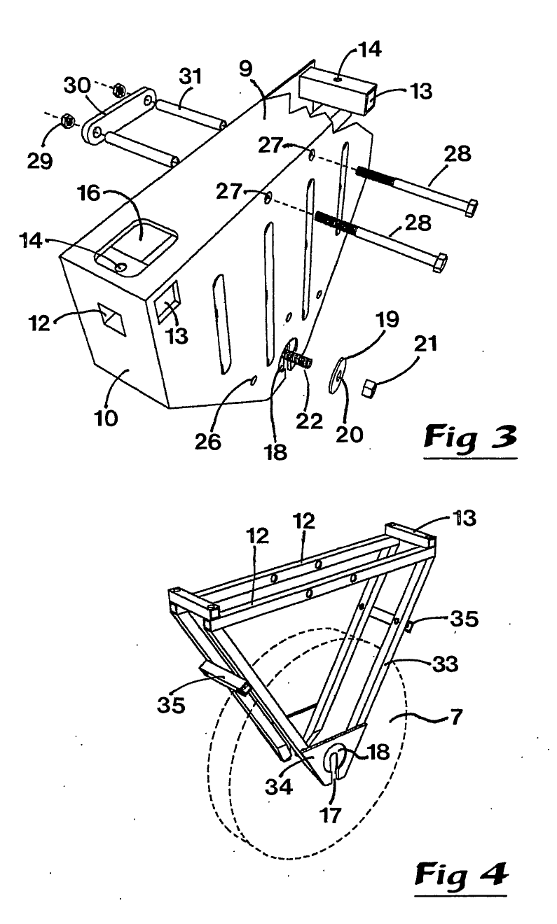

In FIG. 1 an example of a vehicle is illustrated that is constructed from a number of components that are included in a kit according to the invention, which kit is illustrated in outline in FIGS. 2 and 3. In FIG. 1, number 1 designates in general the assembled vehicle, which in the example consists of a four wheeler, more precisely a four wheeler having two pairs of longitudinally separated wheels that are mutually rigidly connected to one another. Primarily, the vehicle comprises a wheel borne frame on which an arbitrary superstructure 2 can be mounted; for example, a wagon-floor. The kit shown in FIGS. 2 and 3 includes two main components, namely a module which in its entirety is designated 3 and in this case is a wheel-module or wheel-unit, as well as a number of connecting members 4. In addition a number of locking members 5 are included. The separate wheel module is in turn comprised of two parts, namely the carrier 6 and at least one wheel 7.

In the embodiment according to precisely FIGS. 2 and 3, the carrier 6 is constructed from two mutually separated side pieces 8 and a top piece 9. In addition the side pieces can be mutually connected via opposite gable pieces 10 (of which only one is visible in the figures). In practice the carrier can be manufactured advantageously from stamped and bent sheet metal, which in the bent state forms a stiff and statically defined construction that is connected, for example, by. welding. In addition the side pieces can be provided with stiffenings 11 by die stamping or by other means.

Distinguishing for the shown wheel module is that its carrier 6 comprises a number of sockets in which connecting members 4 can be inserted. In the actual example the carrier 6 comprises three sockets, namely a longitudinal socket 12 and two transverse sockets 13. The two sockets 13 are parallel relative to one another and extend at an angle, more precisely a right angle, relative to the longitudinal socket 12. In its simplest embodiment a particular socket can consist of a simple hole in a side piece 8 or gable piece 10 respectively, but in practice a pipe coupling or hollow profile is used that is fastened at each end to a side piece or gable piece, for example, by welding. Thus, the single transverse socket 13 (see FIG. 3) consists of a short hollow profile, both opposite ends of which are fastened to the side pieces 8. It is advantageous to have the hollow profile opened at each of its opposite ends so that a connecting member 4 can be inserted from either side in the socket and also be displaced towards arbitrarily directions relative to the socket. In an analogous way the socket 12 consists of a hollow profile that is fastened to both of the carrier's opposite gable pieces 10, but being longer than those hollow profiles that serve as transverse sockets.

As is apparent from FIG. 3 the sockets 12 and 13 respectively, are positioned in different planes. Thus, in the example each transverse socket 13 is located in a plane immediately above the plane in which the longitudinal socket 12 is located. Most suitably the longitudinal socket 12 is located centrally, i.e. halfway between the two side pieces 8 of the carrier. At the geometrical intersection point of the longitudinal socket and a single transverse socket a vertical through hole 14 is made in which the locking member 5 can be inserted. This locking member can in practice consist of a pin, a tap, a screw or the like.

The separate connecting member 4 consists in the example of a square profile with an external cross section that corresponds to the internal cross section of the sockets. In this way the hollow profiles 4 can be inserted with a fairly close or play free fit into the sockets while attaining a torsion resistant connection between them. In the single hollow profile 4 is made at least one hole 15 for receiving a locking member 5. In the depicted preferred embodiment each hollow profile 4 comprises a series of axially separated holes that are suitably equidistantly positioned. By choosing a certain hole in the series, the particular hollow profile 4 can be secured in different positions in the corresponding socket. As is shown in FIGS. 2 and 3 in connection with each transverse socket 13 there is found an access opening 16 in the box-like top piece 9 of the carrier. Every such opening can with advantage be made closable by the use of a cover (not shown), for example, a snap-on cover which serves to hide the interior of the carrier.

In the case where a transverse connecting member 4 and a longitudinal connecting member 4 are inserted at the same time in the corresponding sockets 13 and 12 respectively, and the holes 15 are aligned with the hole 14, one locking member 5 can be inserted through all the holes and thereby lock the connecting members reciprocally as well as relative to the carrier.

Further, the carrier in the example comprises means for attachment of the wheel 7. In the example this means consists of, in each side piece 8, a slit-like recess 17 that opens outwards in the edge section of the side piece. More precisely, the recess 17 is oblong and opens downwards. In connection with the recess 17 is formed a counter bore 18, for example a circular counter bore for a washer 19 having a through hole 20. When placed in the counter bore 18 the washer can not move in a vertical direction relative to the side piece 8. Together with the washer is found a threaded nut 21 which is screwed onto the wheel's shaft end 22 having a male thread and extending through the hole 20.

From the above it is apparent that the wheel 7 in this case is disengageably connected to the carrier. More precisely the wheel can be removed from the carrier by unscrewing the nut 21 and lifting the washer 19 out of the counter bore 18. In this way the shaft end 22 can be removed from the recess 17.

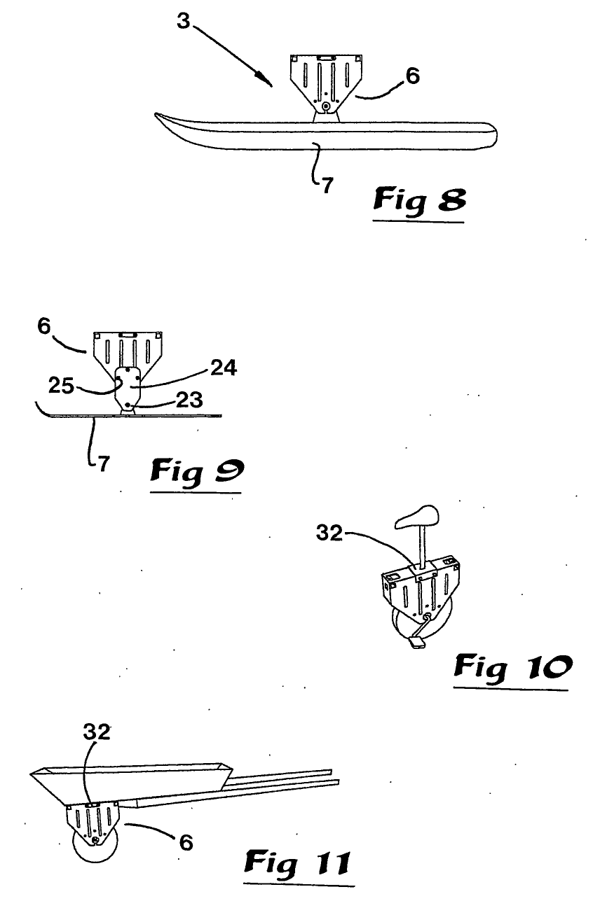

In this context it should be mentioned that the wheel 7 in the example according to FIGS. 2 and 3 forms the component that stands in contact with the surface and which makes it possible for the described module to run along said surface. As was earlier pointed out, however, the module can be equipped with other arbitrary running members of which two are illustrated in FIGS. 8 and 9. Thus, in FIG. 8 is shown a module, to the carrier 6 of which is attached a running member consisting of a pontoon 7. By replacing the wheel with a pontoon (or an other hull), the kit according to the invention allows construction of water borne crafts or vehicles.

In FIG. 9 a module is shown with a ski 7 as a running member. This ski is via a joint 23 connected to a bracket 24, which in turn is rigidly connected to the carrier 6 (in this case) by three fastening members 25 (i.e. pins or bolts) which may be applied in a corresponding number of holes 26 in one of the side pieces of the carrier (see FIGS. 2 and 3).

Now reference is again made to FIGS. 2 and 3 from which it is apparent that additional holes 27 are made in the side pieces 8, more precisely adjacent to the top piece 9 of the carrier. In these holes 27, two bolts 28 can be inserted having male threads that engage the nuts 29 which can be tightened down against a fastening member 30 that, in the example, has the shape of a long narrow plate with holes for the bolts. Distance tubes 31 can be placed between the fastening member 30 and the bolt heads in order to avoid deformation of the side pieces of the carrier when tightening the bolts. Various components can be fixed between the fastening member 30 and one side of the carrier, for example, by clamping the component between the fastening member 30 and the side piece of the carrier. It is also possible to use the described arrangement in other ways; for example, in the way indicated in FIGS. 10 and 11 respectively. I these cases the bolts 28 are inserted through holes in a saddle plate 32 having a U-formed cross section.

Now reference is made to FIG. 4 which illustrates an alternative embodiment of the carrier of the module according to the invention. In this case every form of box-like casing is lacking. Instead the carrier consists of a number of hollow profiles, which are rigidly connected to one another; for example, by welds, and of which certain of these serves as sockets. More precisely, the shown carrier comprises two upper, longitudinal hollow profiles 12, which serve as two longitudinal sockets for interacting with connecting members (not shown), as well as two transverse hollow profiles 13, which extend at right angles to the hollow profiles 12 and which have the function of receiving transversely positioned connecting members. Inclined legs 33, also made from hollow profiles, extend obliquely downwards from the opposite sides of the hollow profiles 12. Said legs are bound together in pairs via bottom pieces 34; for example, in the shape of triangular plates in which is made a U-shaped recess 17 together with a counter bore 18. Laterally the pairs of legs 33 are in addition connected via the stiffening cross pieces 35.

In FIG. 5 is given an indication of how a carrier 6 of a wheel module can be designed with a top piece in the shape of a box girder 36 in which is mounted a screw mechanism; for example, an Allen screw 37, which when turned in the one or the other direction activates a number of locking members in the shape of band-shaped claws 38 to move in or out of long narrow slots 39 in the side of the girder. By contracting these claws other objects, such as accessories of different types (not shown) and/or connecting members can be applied and fixed against the box girder by clamping.

In FIG. 6 another alternative carrier to a wheel module is shown. This variation differs from the design illustrated in FIG. 4 mainly in that the sockets 12, 13 are formed from tubs having circular cross section rather than hollow profiles with a square or polygonal cross section. In this case even the corresponding connecting members are supposed to consist of tubes having circular cross section that are inserted into and attached to the sockets 12, 13. A similar attachment can be accomplished either by having a torsion resistant connection between the connecting member and the socket (e.g. by using a locking member in a hole 14), or by allowing a relative rotation between the connecting member and the socket (i.e. axial movement between the connecting member and the socket is inhibited in a suitable way while permitting a mutual rotational movement).

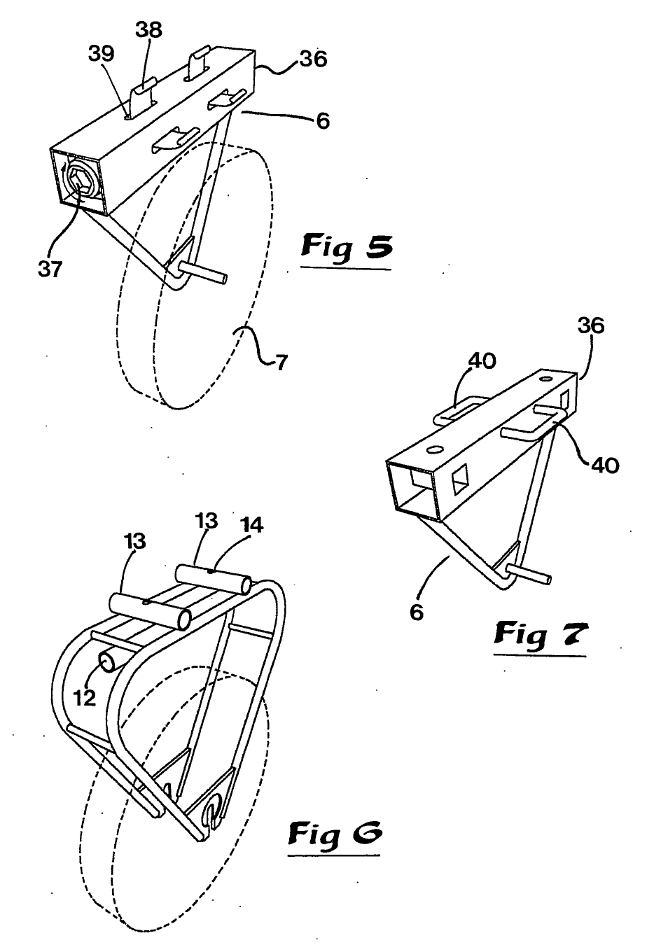

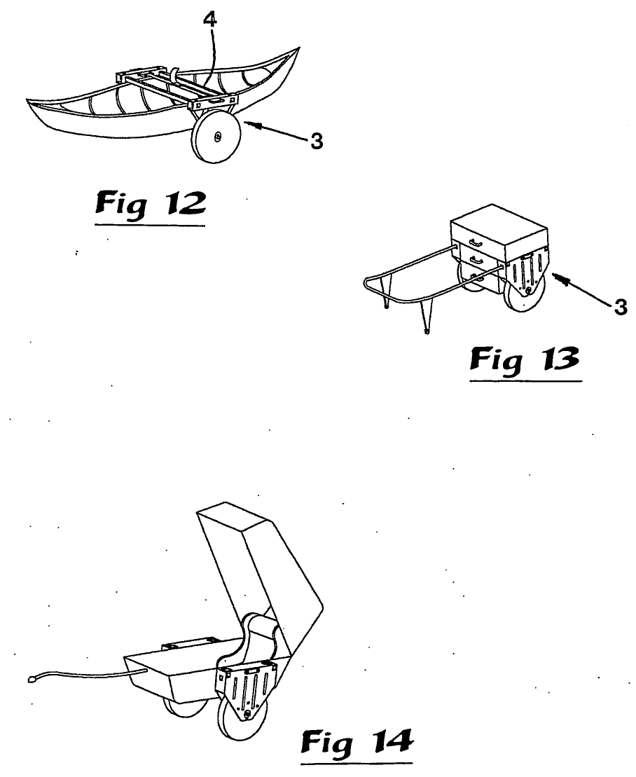

Finally, in FIG. 7 is shown how a carrier 6 and in particular its top piece 36 can be designed with at least one and suitably two handles to which a load can be secured (compare FIG. 12).

From the foregoing it ought to be clear that the described kit comprising as the main components on the one hand a module in which is included a running member and on the other hand a number of connecting members, can be applied in a universal way for construction/assembly of vehicles of the most varying types. An exhaustive account of all possible types of vehicles that could feasibly be made is not possible since it is only the user's fantasy that puts limits on what could be constructed. Nevertheless, with the aim of further concretising the possibilities that the invention offers, the following presents a brief description of a few conceivable embodiments of different vehicles in practice.

In FIG. 10 a single wheeled vehicle is shown (a unicycle), which besides a wheel module according to FIGS. 2 and 3 comprises a saddle on a column, which in turn is fastened to the carrier of the wheel module by an earlier described saddle plate 32. In addition the wheel shaft has been equipped with cycle pedals.

In FIG. 11 still another single wheeled vehicle is depicted, namely a wheelbarrow, which similar to the unicycle of FIG. 10 comprises a wheel module 3 as described in the foregoing.

In FIG. 12 a two wheeled vehicle is illustrated in the shape of a canoe wagon. In this case the wagon is comprised of two wheel modules which are mutually rigidly connected to one another through transverse connecting members 4, the length of which decides the width of the vehicle. By utilizing a band that passes through the handles 40 of the type shown in FIG. 7, and which band also passes around a canoe that is located between the two wheel modules, the canoe can be drawn up against and be carried underneath the connecting members.

In FIG. 13 another two wheeled vehicle is shown in the shape of a cart for transporting a pedestal with drawers; for example, tool chests. In this case the two wheel modules 3 are connected together using the pedestal and by using the fastening members 28, 30 of the type that are shown in FIG. 3; besides which a trailer hitch suitable for the task, for example a U-shaped thill, is applied to the longitudinal sockets 12 of the carrier 6.

In FIG. 14 still another two wheeled vehicle is illustrated in the shape of a wagon, for example a baby buggy. The wagon is equipped with a hitch that allows connection to a pulling vehicle, such as a bicycle, or that can be utilized for manual movement of the wagon by pushing or pulling.

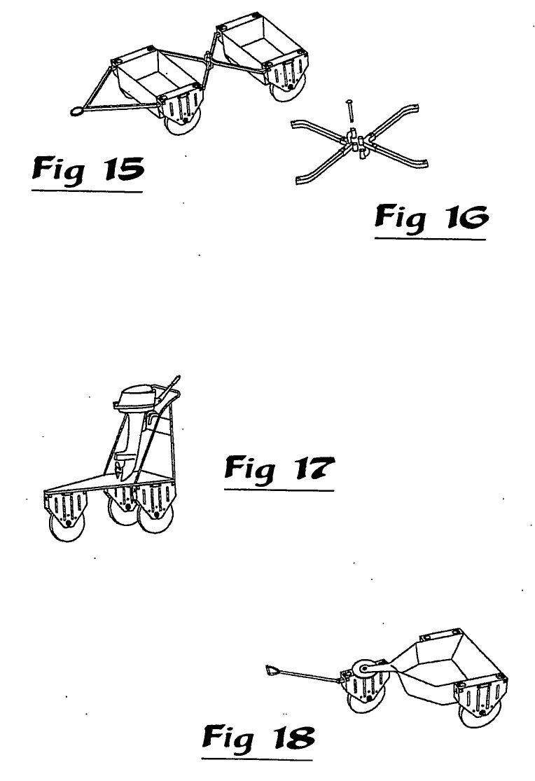

In FIG. 15 is depicted a four wheeled vehicle, which is comprised of two bogies, each consisting of two wheel modules as well as a load carrying member such as a box arranged between them. The two bogies are connected through a link arrangement depicted in FIG. 16, and formed by two V-shaped connecting members that are mutually connected via a joint. The joint allows for a sideways turning motion between the bogies. At least one of the bogies can be equipped with a trailer hitch for connection to a suitable pulling vehicle.

In FIG. 17 a three wheeled transport cart is shown having a frame with three rigidly connected wheel modules. Arbitrary objects can be transported using such a cart; for example, outboard boat motors.

Even the cart shown in FIG. 18 has three wheels. In this case, however, one of the three wheels may turn or swivel relative to the other two resulting in a dirigible vehicle.

### Feasible Modifications of the Invention

The invention, as indicated above, is in no way limited only to the above described and in the drawings shown embodiments. Thus, within the scope of the following claims, the modules as well as the connecting members that are comprised in the kit, can be most considerably modified. As an example, the connecting members can be made as telescoping embodiments, i.e. comprising two or more tubes or hollow profiles which are telescopically displaceable relative to each other and mutually fixable. In this way the length of one and the same connecting member can be varied. Basic for the invention is herewith mainly and solely that the module included in the kit, irrespectively of the type of running member said module is equipped with, comprises sockets in which interacting connecting members are allowed to be disengageably applied.

1-15. (canceled)

16. A module for constructing different variations of vehicles (1), comprising a carrier (6), which consists of means (17) for attachment of a running member (7), for example, a wheel, a ski, a pontoon, or the like, and which carrier comprises several sockets (12,13) for attachment of connecting members therein, characterized in that said sockets (12,13) are arranged at an angle to one another.

17. A module according to claim 16, characterized in that the angle between the sockets is perpendicular.

18. A module according to claim 16, characterized in that the carrier comprises several sockets, which are arranged parallel to one another.

19. A module according to claim 16, characterized in that the single socket (12,13) extends completely through the carrier (6) between two opposite, open ends.

20. A module according to claim 16, characterized in that the carrier (6) comprises a top piece (9) adjacent to which the sockets (12,13) are arranged, as well as at least one side piece (8) comp- rising said attachment means (17).

21. A module according to claim 20, characterized in that the attachment means is made up of an outwards open recess (17) in the side piece (8).

22. A module according to claim 21, characterized in that in the side piece (8) and in connection with the recess (17) is formed a counter bore (18), which is wider than the recess and which has the function of forming a seat for a washer (19) having a hole (20) and which washer is applicable to a fastening member (22) belonging to the running member.

23. A module according to claim 22, characterized in that the fastening member of the running member is made up of a journal (22) having a male thread and being arranged to interact with a nut (21), which can be tighten against the washer (19).

24. A module according to claim 20, characterized in that the side piece of the carrier (8) has a number of separate holes (26) which interacts with a corresponding number of pins arranged on the running member (7) for rigid connection between the running member and the carrier.

25. A kit for constructing different variations of vehicles, characterized in that said kit comprises a number of modules (3) according to claim 16, as well as a number of connecting members (4) which are insertable in the sockets (12,13) of the module.

26. A kit according to claim 25, characterized in that the separate connecting member (4) has a long and narrow shape and comprises several parts that are telescopically displaceable relative to one another.

27. A kit according to claim 25, characterized in that the separate connecting member comprises one or more holes (15) for interaction with a locking member (5).

28. A kit according to claim 25, characterized in that one and the same locking member (5) is arranged to commonly lock two intersecting connecting members (4), relative to one another as well as relative to the carrier (6).

29. A kit according to claim 25, characterized in that the carrier (6) comprises a number of locking members (38), which are arranged to fasten other objects relative to the carrier (6) by clamping.

30. A vehicle, characterized in that said vehicle is built from a number of modules (3), as well as a number of connecting members (4) included in the kit according to claim 25, more precisely by having connecting members (4) inserted and locked in the sockets (12,13) of the module.
